(19) United States
(12) Patent Application Publication
(10) Pub. No.: US 2005/0195817 A1
(43) Pub. Date: Sep. 8, 2005

(54) Switching device and multicast packet processing method therefor

(75) Inventors: Chen-Yu Chen, Tu-Cheng (TW); Tsvng-Yin Hsieh, Tu-Cheng (TW); Jain-Chung Wang, Tu-Cheng (TW); Hsiao-Wen Sun, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/070,800

(22) Filed: Mar. 2, 2005

(30) Foreign Application Priority Data
Mar. 6, 2004 (CN) 200410026474.X

(51) Int. Cl. H04L 12/28

(52) U.S. Cl. 370/390

(57) ABSTRACT

A switching device includes: an Internet Group Management Protocol (IGMP) snooping module (101), a packet dispatching module (103), a plurality of ports (105), a router physical abstraction layer (router HAL) (102) including a forwarding table (1020), and a Flash memory (104) including a port table (1040), a recording table (1041) and a routing table (1042). The packet dispatching module identifies whether a received packet via one port is an IGMP packet, and sends the IGMP packet to the IGMP snooping module. The IGMP snooping module adds a number of the port and a routing relationship respectively to the port table and the routing table, and sends a notice to the router HAL to add a corresponding mapping relationship to the forwarding table. Then the IGMP snooping module transfers multicast data packets according to contents of the forwarding table. A related method for processing a multicast packet is also provided.

### BACKGROUND OF THE INVENTION

1. Field of the Invention

The present invention relates to network communication devices and methods, and especially to a switching device and a multicast packet processing method therefor.

2. Prior Art

Point-to-multipoint transmission is becoming increasingly important as the number of Internet and Local Area Network (LAN) applications that rely on multicast transmission continues to rise. Herein, “multicast” means to transmit information to a group of users (i.e., a “multicast group”) by way of a server. Without multicast services, applications dependent upon such services are forced to send information to groups of users with unicast packets. This means that a server, for instance, sends an individual copy of each data packet to each of all the users in an interest group (e.g., a Virtual LAN-“VLAN”) or in another kind of multicast group such as an Internet Protocol (IP) multicast group. Unicasting to dispersed groups of users is inefficient for both the data resource and the network bandwidth. With multicast services, a server sends out a single packet only. The packet is automatically copied by network devices such as multicast routers or switches, which then distribute the copied packets to every end station in the target group of users. In this manner, the network bandwidth and data resources are used efficiently by the network controlling device.

U.S. Pat. No. 6,457,059, issued on Sep. 24, 2002, discloses a method and apparatus for transmitting multicast data in a switched LAN environment. Referring to FIG. 5, when a multicast processing section 40 receives a multicast packet via one port 41, a packet determining/switching processing section 401 determines whether the multicast packet is an Internet Group Management Protocol (IGMP) packet. In general, the multicast packet may be an IGMP packet or a multicast data packet. If the packet is an IGMP packet, an IGMP processing section 400 determines a type of the IGMP packet, and operates the IGMP packet according to the type of the IGMP packet. The type of the IGMP packet can be a querying message, a reporting message, or a leaving message. A port number-multicast address correlation storing section 42 stores a mapping relationship between a number of the port 41 and a multicast address, the multicast address being an address of a host connected to the port 41 as a member of a multicast group. The IGMP processing section 400 then transfers the multicast data packets to corresponding hosts according to contents of the port number-multicast address correlation storing section 42.

Although the IGMP processing section 400 stores the mapping relationships in the port number-multicast address correlation storing section 42, and transfers the multicast data packets according to the contents thereof, the IGMP processing section 400 does not check states of the ports 41 over time in order to update the contents of the port number-multicast address correlation storing section 42. Therefore, the multicast data packet transmission is liable to operate inefficiently. Accordingly, there is a need for a means and method for processing multicast packets efficiently.

### SUMMARY OF THE INVENTION

A primary object of the present invention is to provide a switching device for processing multicast packets efficiently.

A secondary object of the present invention is to provide a method for processing multicast packets efficiently, which utilizes the above-mentioned switching device.

In order to accomplish the above-mentioned primary object, the present invention provides a switching device includes: an Internet Group Management Protocol (IGMP) snooping module, a packet dispatching module, a plurality of ports, a router physical abstraction layer (router HAL) including a forwarding table, and a Flash memory including a port table, a recording table and a routing table. The packet dispatching module identifies whether a received packet via one port is an IGMP packet, and sends the IGMP packet to the IGMP snooping module. The IGMP snooping module adds a number of the port and a routing relationship respectively to the port table and the routing table, and sends a notice to the router HAL to add a corresponding mapping relationship to the forwarding table. Then the IGMP snooping module transfers multicast data packets according to contents of the forwarding table.

In order to accomplish the above-mentioned secondary object, a method for processing a multicast packet is provided. The method comprises the steps of: (a) receiving the packet; (b) determining whether the packet is an IGMP packet; (c) determining whether the packet belongs to 224.0.0.x group, if the packet is an IGMP packet; (d) determining whether the packet is a joining message, if the packet does not belong to the 224.0.0.x group; (e) processing the packet in the IGMP snooping module, if the packet is a joining message; or (f) determining whether the packet is a leaving message, if the packet is not a joining message; and (g) removing a number of a port that receives the packet from a port table, removing a routing relationship between the number of the port and an IP multicast address (being an IP address of a host connected to the port as a member of a multicast group) from a routing table, and removes a mapping relationship between the number of the port and a corresponding MAC address from a forwarding table.

Step (e) of the above-described method comprises the steps of: (i) determining whether the routing relationship is in the routing table; (ii) determining whether the number of the port is in the port table, if the routing relationship is in the routing table; (iii) determining whether the mapping relationship is in the forwarding table, if the number of the port is in the port table; and (iv) adding the mapping relationship to the forwarding table, if the mapping relationship is not in the forwarding table.

Other objects, advantages and novel features of the present invention will be drawn from the following detailed description of the present invention with the attached drawings, in which:

### BRIEF DESCRIPTION OF THE DRAWINGS

FIG. 1 is a block diagram of a topology of a multicast-supporting VLAN in accordance with a preferred embodiment of the present invention, the VLAN comprising switching devices and hosts;

FIG. 2 is a block diagram of one switching device of the VLAN of FIG. 1;

FIG. 3 is a flow chart of one switching device of the VLAN of FIG. 1 receiving and processing an IGMP packet in accordance with the present invention;

FIG. 4 is a flow chart of one switching device of the VLAN of FIG. 1 processing a joining message from one host in accordance with the present invention; and

FIG. 5 is a block diagram of a conventional switching device.

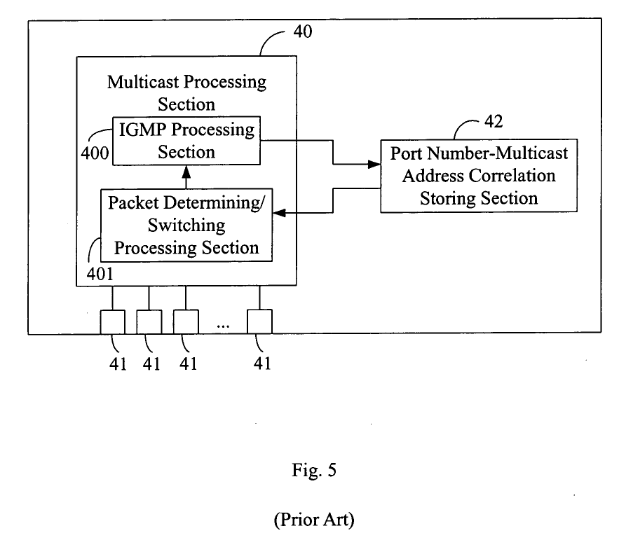

### DETAILED DESCRIPTION OF THE INVENTION

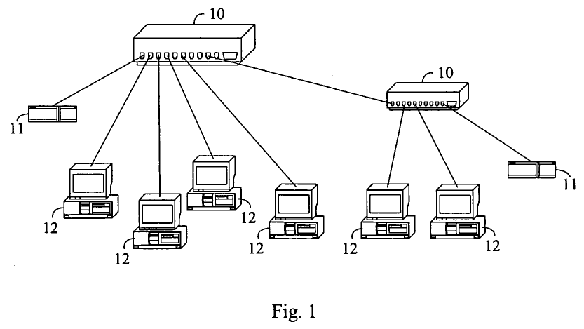

FIG. 1 is a block diagram of a topology of a multicast-supporting Virtual Local Area Network (VLAN) according to the preferred embodiment of the present invention. The multicast-supporting VLAN comprises two switching devices 10 connected with each other, two multicast routers 11, and a plurality of hosts 12 connected to the switching devices 10. Each of the switching devices 10 is connected to a respective multicast router 11. The hosts 12 are typically personal computers (PCs) or computer workstations known in the art. In the preferred embodiment, the multicast routers 11 and the hosts 12 comply with Internet Group Management Protocol (IGMP).

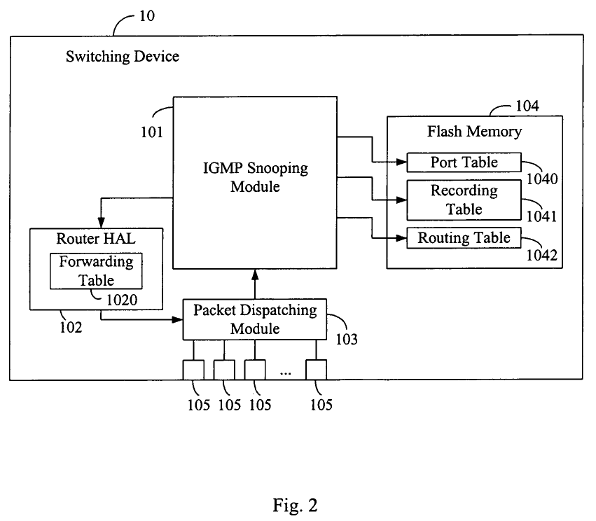

FIG. 2 is a block diagram of components of one of the switching devices 10. The other switching device 10 has the same structure as that of the illustrated switching device 10. The switching device 10 comprises an IGMP snooping module 101, a router physical abstraction layer (router HAL) 102, a packet dispatching module 103, a Flash memory 104, and a plurality of ports 105. The Flash memory 104 comprises a port table 1040, a recording table 1041, and a routing table 1042. The router HAL 102 comprises a forwarding table 1020. The ports 105 are individually connected to the multicast routers 11 or the hosts 12. In an alternative embodiment, the Flash memory 104 can be another kind of nonvolatile memory.

When the packet dispatching module 103 receives a packet from one host 12 via one port 105, the dispatching module 103 determines whether the multicast packet is an IGMP packet. If the packet is an IGMP packet, the packet dispatching module 103 sends the IGMP packet to the IGMP snooping module 101. The IGMP snooping module 101 determines whether the packet belongs 224.0.0.x group. If the packet does not belong to the 224.0.0.x group, the IGMP snooping module 101 determines a type of the IGMP packet. The type of the IGMP packet may be a querying message, a reporting message, a joining message, or a leaving message.

A joining message or a leaving message is transmitted from a host 12 to a multicast router 11 in order for the host 12 to join or leave a multicast group. A querying message is transmitted from a multicast router 11 to each of the hosts 12 to query whether the host 12 wants to become a member of one multicast group. A reporting message, as a response to the querying message, is transmitted from one of the hosts 12 to the multicast router 11. The reporting message indicates that the hosts 12 is to become a member of a multicast group.

If the IGMP packet is a joining message, the IGMP snooping module 101 adds a routing relationship between the number of the port 105 and an IP multicast address (that is, an IP address of the host 12 as a member of a multicast group) to the routing table 1042, and adds a number of the port 105 that receives the joining message to the port table 1040. In the preferred embodiment of the present invention, the contents of the port table 1040 are numbers of the ports 105. The contents of the routing table 1042 are routing relationships between the numbers of the port 105 and the IP multicast addresses. At the same time, the IGMP snooping module 101 sends a notice to the router HAL 102 to add a mapping relationship between the number of the port 105 and a media access control (MAC) multicast address to the forwarding table 1020. In the preferred embodiment of the present invention, contents of the forwarding table 1020 are mapping relationships between the numbers of the ports 105 and the MAC multicast addresses. When the router HAL 102 receives the notice, the router HAL 102 adds the mapping relationship to the forwarding table 1020.

When one port 105 receives a multicast data packet, the IGMP snooping module 101 fetches an IP address of the multicast group included in a header of the multicast data packet, which is also stored in the routing table 1042. Then the IGMP snooping module 101 converts the IP address to a multicast MAC address, which is stored in the forwarding table 1020, and transfers multicast data packets to corresponding hosts 12 via ports 105 according to the contents of the forwarding table 1020.

In different time periods, the ports 105 may be in an active state or an inactive state. When in the active state, the ports 105 receive joining messages. When in the inactive state, the ports 105 do not receive joining messages. In the preferred embodiment, when a predefined time period elapses, the numbers of the ports 105 that were in the active state during said period are stored in the port table 1040. Then, the IGMP snooping module 101 compares the contents of the port table 1040 with contents of the recording table 1041, which stores the contents of the port table 1040 at the beginning of the time period. If there are contents that exist in the recording table 1041 but not in the port table 1040, which indicates several ports 105 not having received joining messages from hosts 12 during the time period, the IGMP snooping module 101 records the ports 105 and copies the contents of the port table 1040 to the recording table 1041 to replace the contents therein.

The contents that exist in the recording table 1041 but not in the port table 1040 may be information on one port 105 only or information on several ports 105. In the described embodiment, the contents are information on one port 105 only. When the IGMP snooping module 101 checks that there is a port 105 not having received joining message during the time period, the IGMP snooping module 101 sends a querying message to ask a host 12 that is connected to the port 105 to join one multicast group. If the host 12 elects to join a multicast group, the host 12 sends a reporting message to the IGMP snooping module 101. If the host 12 does not elect to join any multicast group, the IGMP snooping module removes the number of the port 105 from the port table 1040 and removes the routing relationship from the routing table 1042, then sends a notice to the router HAL 102 to remove the relevant mapping relationship from the forwarding table 1020.

If the IGMP packet is a leaving message, the IGMP snooping module 101 removes the number of the port 105 from the port table 1040 and removes the routing relationship from the routing table 1042, then sends a notice to the router HAL 102 to remove the relevant mapping relationship from the forwarding table 1020. In addition, the IGMP snooping module 101 also periodically receives a querying message from the multicast router 11, to ask all hosts 12 to respectively join multicast group.

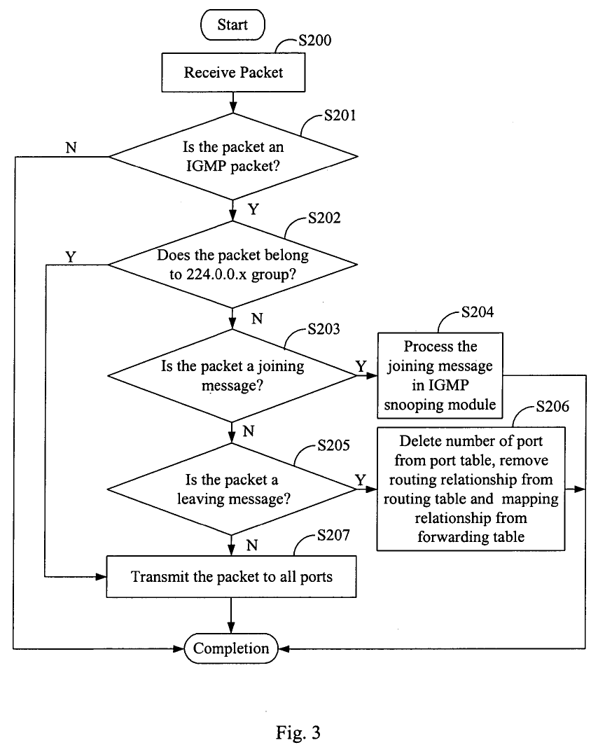

FIG. 3 is a flow chart of one switching device 10 receiving and processing an IGMP packet in accordance with the present invention. At step S200, one of the ports 105 receives a packet. At step S201, the packet dispatching module 103 determines whether the packet is an IGMP packet. If the packet is not an IGMP packet, the process is completed.

If the packet is an IGMP packet, at step S202, the IGMP snooping module 101 determines whether the IGMP packet belongs to 224.0.0.x group, which range is from 224.0.0.0 to 224.0.0.255. If the IGMP packet belongs to the 224.0.0.x group, the IGMP packet is sent to all ports.

If the IGMP packet does not belong to the 224.0.0.x group, at step S203, the IGMP snooping module 101 determines whether the IGMP packet is a joining message. If the IGMP packet is a joining message, at step S204, the IGMP snooping module 101 processes the joining message, whereupon the process is completed.

If the IGMP packet is not a joining message, at step S205, the IGMP snooping module 101 determines whether the IGMP packet is a leaving message. If the IGMP packet is a leaving message, at step S206, the IGMP snooping module 101 removes the number of the port 105 from the port table 1040 and removes the routing relationship from the routing table 1042, and sends a notice to the router HAL 102 to remove the relevant mapping relationship from the forwarding table 1020. Thereupon the process is completed.

If the IGMP packet is not a leaving message, at the step S207, the IGMP snooping module 101 considers the IGMP packet as an indeterminate IGMP packet, and sends it to all the ports 105. Thereupon the process is completed.

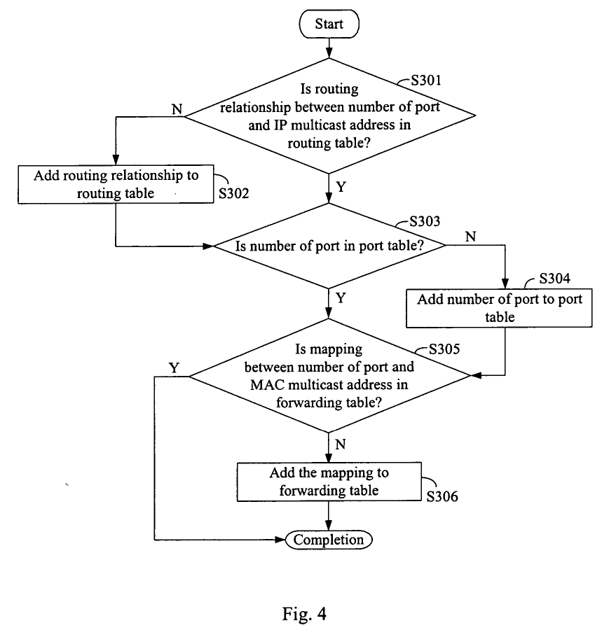

FIG. 4 is a flow chart of one switching device 10 processing a joining message from one host 12 in accordance with the present invention. At step S301, the IGMP snooping module 101 determines whether a routing relationship between the number of the port 105 and the IP multicast address is in the routing table 1042. If the routing relationship is not in the routing table 1042, at step S302, the IGMP snooping module 101 adds the routing relationship to the routing table 1042.

If and when the routing relationship is in the routing table 1042, at the step S303, the IGMP snooping module 101 determines whether the number of the port 105 is in the port table 1040. If the number of the port 105 is not in the port table 1040, at the step S304, the IGMP snooping module 101 adds the number of the port 105 to the port table 1040.

If and when the number of the port 105 is in the port table 1040, at the step S305, the IGMP snooping module 101 determines whether the mapping relationship between the number of the port 105 and a MAC multicast address is in the forwarding table 1020. If the mapping relationship is not in the forwarding table 1020, at step S306, the IGMP snooping sends a notice to the router HAL 102 to add the mapping relationship to the forwarding table 1020. If and when the mapping relationship is in the forwarding table 1020, the process is completed.

Although only preferred embodiments and methods of the present invention have been described in detail above, those skilled in the art will readily appreciate that many modifications to the preferred embodiments and methods are possible without materially departing from the novel teachings and advantages of the present invention. Accordingly, all such modifications are deemed to be covered by the following claims and allowable equivalents of the claims.

1. A switching device for processing multicast packets, comprising:
a packet dispatching module for identifying whether each of received packets is an Internet Group Management Protocol (IGMP) packet;
an IGMP snooping module for processing IGMP packets and transferring multicast data packets;
a plurality of ports for connecting to hosts and/or multicast routers; and
a router abstraction layer (router HAL) for forming routing relationships between the ports and media access control (MAC) multicast addresses.

2. The switching device as claimed in claim 1, further comprising a nonvolatile memory for storing information on numbers of the ports and routing relationship between the number of the ports and IP multicast addresses, the IP multicast addresses being addresses of hosts as members of multicast groups.

3. The switching device as claimed in claim 2, wherein the nonvolatile memory comprises a port table for storing the numbers of the ports.

4. The switching device as claimed in claim 2, wherein the nonvolatile memory comprises a recording table for storing contents of the port table at one or more particular points in time.

5. The switching device as claimed in claim 2, wherein the nonvolatile memory comprises a routing table for storing the routing relationships.

6. The switching device as claimed in claim 1, wherein the router HAL comprises a forwarding table for storing the mapping relationships between the numbers of the ports and MAC multicast addresses, the MAC multicast addresses being addresses of hosts as members of multicast groups.

7. A method for processing a multicast packet, the method comprising the steps of:
(a) receiving the packet;
(b) determining whether the packet is an Internet Group Management Protocol (IGMP) packet;
(c) determining whether the packet belongs to 224.0.0.x group, if the packet is an IGMP packet;
(d) determining whether the packet is a joining message, if the packet does not belong to the 224.0.0.x group;
(e) processing the packet by an IGMP snooping module, if the packet is a joining message; or
(f) determining whether the packet is a leaving message, if the packet is not a joining message; and
(g) removing a number of a port from a port table, removing a routing relationship between the number of the port and an IP multicast address from a routing table, and removing a mapping relationship between the number of the port and a MAC address from a forwarding table, if the packet is a leaving message.

8. The method for processing a multicast packet as claimed in claim 7, further comprising the step of transmitting the packet to all of ports associated with the IGMP snooping module, if the IGMP packet is not a leaving message.

9. The method for processing a multicast packet as claimed in claim 7, wherein step (e) comprises the step of:
(e1) determining whether the routing relationship is in the routing table;
(e2) determining whether the number of the port is in the port table, if the routing is in the routing table;
(e3) determining whether the mapping relationship is in the forwarding table, if the number of the port is in the port table; and
(e4) adding the mapping relationship to the forwarding table, if the mapping relationship is not in the forwarding table.

10. The method for processing a multicast packet as claimed in claim 9, wherein step (e1) further comprises the step of adding the routing relationship to the routing table, if the routing relationship is not in the routing table.

11. The method for processing a multicast packet as claimed in claim 9, wherein step (e2) further comprises the step of adding the number of the port to the port table, if the number of the port is not in the port table.

12. A method for processing a multicast packet, comprising the steps of:
receiving said packet;
identifying said packet as complying with Internet Group Management Protocol (IGMP);
identifying said packet as a predefined message complying with IGMP;
modifying a processing way of said packet based on said predefined message in case that said packet is said predefined message complying with IGMP; and
processing said packet based on said processing way.

13. The method as claimed in claim 12, further comprising the step of querying a host to join a group of receiving said packet in case that said host is in an inactive connection of receiving said packet.

14. The method as claimed in claim 12, further comprising the step of transmitting said packet to all available hosts in case that said packet is identified as being in a 224.0.0.x group before said predefined-message-identifying step.

15. The method as claimed in claim 12, wherein said packet is identified as a joining message in order for defining said processing way to add a host sending said joining message into a group of packet-receiving in said modifying step.

16. The method as claimed in claim 12, wherein said packet is identified as a leaving message in order for defining said processing way to delete a host sending said leaving message out of a group of packet-receiving in said modifying step.
